(19) United States
(12) Patent Application Publication
(10) Pub. No.: US 2009/0095587 A1
(43) Pub. Date: Apr. 16, 2009

(54) SYSTEM AND METHOD FOR ATTAINING AND MAINTAINING HYDRAULIC PRESSURE FOR LOCKING A VEHICLE'S WHEELS

(75) Inventors: Richard R. Rowan, Fort Wayne, IN (US); Thomas L. Cumbey, Fort Wayne, IN (US); Duane R. Avery, Woodburn, IN (US)

Correspondence Address: International Truck Intellectual Property Company,, 4201 WINFIELD ROAD, WARRENVILLE, IL, 60555, US

(73) Assignee: International Truck Intellectual Property Company, LLC, Warrenville, IL (US)

(21) Appl. No.: 11/872,350

(22) Filed: Oct. 15, 2007

(51) Int. Cl. B60T 11/10

(52) U.S. Cl. 188/353

(57) ABSTRACT

Hydraulic pressure for wheel lock is kept by trapping suitably pressurized brake fluid between a brake power unit (34) and hydraulic actuators at the brake calipers or shoes at the wheels (22) by a locking mechanism (120) that acts on the brake pedal shaft (128) independently of the brake pedal.

### FIELD OF THE INVENTION

This invention relates generally to hydraulic brake systems of motor vehicles and in particular to a system and method for attaining and maintaining hydraulic pressure at hydraulic-actuated service brakes at the wheels to lock the wheels while the vehicle is parked.

### BACKGROUND OF THE INVENTION

Hydraulic service brakes of a motor vehicle are typically actuated when a driver of the vehicle depresses a brake pedal. Depression of the pedal causes hydraulic brake fluid that is trapped in brake lines between a master cylinder and hydraulic actuators at the wheels to be displaced in a manner that moves either a shoe in the case of a shoe brake or calipers in the case of a disc brake to frictionally engage either a drum or a rotor that turns with the wheel.

Typically pedal movement is transmitted by a linkage to the master cylinder to move the hydraulic brake fluid. In a split brake system, meaning a system having separate hydraulic circuits, one for front wheel brakes and another for rear wheel brakes, the master cylinder has two pistons in tandem that are linked to the pedal lever assembly by the master cylinder input rod. One piston forces hydraulic brake fluid to the front wheel brakes and the other forces fluid to the rear wheel brakes. A brake system typically includes some form of pressure amplification or power assist to reduce the force that the driver would otherwise have to apply to operate the brakes in the absence of such an aid.

Motor vehicles are also customarily equipped with a park brake that is separate from the service brake. A park brake is used to apply holding force to a stopped wheel and hence is typically set only when a vehicle is parked. Because the wheels are stopped, a typical park brake does not have to apply nearly as great a force to a wheel as does a service brake.

Some motor vehicles are used in ways that at times require them to be extremely stable without any wheel movement when parked, i.e. they must remain completely stationary. Even small wheel movements are not acceptable. Vehicles that are used in the utility, vehicle recovery, multi-stop, and lawn care industries are a few examples of such service vehicles. The degree to which completely stationary status must be maintained is essentially beyond the capability of the usual park brake.

It has heretofore been proposed to use a vehicle's own hydraulic-actuated service brake to achieve the holding force needed for keeping a parked vehicle completely stationary. Such a system is sometimes referred to as a “four wheel lock” system. An example of such a system is one that is sold in the after-market as a kit containing various components including a hydraulic pump, two cylinders, switches, harnesses and a small electronic controller. Such a system achieves the large force needed for wheel lock by trapping pressure at the wheel brakes. This is done by utilizing the aforementioned cylinder to separate two distinct fluid systems; one fluid system is isolated between the aforementioned pump and one side of a piston within the cylinder, while the second fluid system is isolated between the other side of the piston within the cylinder and the wheel brake. In this way when the pump pressurizes the fluid isolated between pump and cylinder piston, the piston imparts fluid pressure to the fluid isolated between the other side of the cylinder piston and the wheel brakes. Thus the pump indirectly controls fluid pressure at the wheel brakes.

Another proposal presumes that a vehicle's hydraulic brake system includes active braking, sometimes referred to as traction control. When the vehicle is parked, an active braking control valve can be actuated to apply pressure for four wheel lock. The architecture of such a system however depends on the integrity of the control valve, a valve that is typically solenoid-operated. In existing solenoid designs, the coil needs to be electrically energized at all times during four wheel lock.

Commonly owned U.S. patent application Ser. No. 11/872,326, filed of even date, (Attorney Docket No. D6049) contains the observation that should the coil fail, the pressure to the brakes would be immediately relieved, releasing the four wheel lock, possibly in a situation where adverse consequences to person and property could result. Furthermore, the need to constantly energize the coil may require that the engine continue running while the feature is in use. Such continual running of the engine may be inappropriate for the particular situation.

The inventors are unaware of any original manufacturer (OEM) of motor vehicles offering a four wheel lock system in vehicles that it makes.

When the components of the after-market kit mentioned above are installed in a new motor vehicle, it is necessary to break the integrity of the factory-installed brake system and related components in order to interface the kit components with the vehicle brake system. Such modification of a new vehicle under OEM factory warranty could have adverse implications on that warranty, apart from risks of incorrect installation and unintended interactions with OEM equipment. The kit uses DOT (Department of Transportation) #5 hydraulic brake fluid in its own hydraulic system that is on one side of the kit's cylinders, while the side of the kit's cylinders that connect into the vehicle's brake system use DOT #3 brake fluid because that is the fluid usually specified by the OEM, creating the risk of mixing fluids or of improper filling of the respective systems.

Furthermore, the vehicle owner incurs the cost of installation and loss of vehicle service time required to retrofit the after-market system to the vehicle. The installation process also typically requires that the installer find available open space suitable for mounting the various kit components and re-plumbing of the brake system.

The commonly owned U.S. patent application referenced above expresses the belief that an OEM-installed four wheel lock system would provide competitive advantages over an after-market installation, advantages that would be important to prospective customers seeking service vehicles intended for use in situations requiring four wheel lock. A factory-installed system could be included as part of the OEM vehicle warranty and can be better integrated with the OEM service brake system.

### SUMMARY OF THE INVENTION

The invention that is the subject of the present patent application relates to a system and method for attaining and maintaining hydraulic pressure for four wheel lock in a system that is like the one that is the subject of the referenced U.S. patent application.

Hydraulic pressure for wheel lock is kept by trapping suitably pressurized hydraulic fluid between a brake power unit and hydraulic actuators at the brake calipers or shoes, not by an active brake control valve in the power unit, but rather by a locking mechanism that has a shaft that is deployed to act on an auxiliary lever on the brake pedal shaft. In this way the brake pedal shaft is kept in a position of service brake application in the same way as if the brake pedal itself were being depressed in a corresponding amount. As set by this locking mechanism, the brake pedal shaft position forces a bounded predictable caliper or shoe pressure for locking the wheels hydraulically.

In a brake system that has active braking, the active brake system can be used in a backup mode in accordance with the invention of this patent application as a contingency against the remote possibility of a fault in the locking mechanism and mechanical linkage to the master cylinder. If the backup mode were invoked due to such a fault, a warning, such as continuously sounding the vehicle's horn, can be given to promptly warn personnel of the condition.

Furthermore, the adequacy of caliper or shoe pressure for locking a wheel doesn't use the existing pressure transducer present in a brake power unit that delivers hydraulic brake fluid to the wheel brake actuators. In a split brake system the front wheel brake system has a front brake power unit and the rear brake system has a rear brake power unit. Each one has its own pressure transducer. In embodiment shown in the present patent application (which is the same as in the one shown in the referenced patent application), two additional pressure transducers are added, one to each power unit for measuring the actual pressure at the front brakes and actual pressure at the rear brakes respectively. An electronic control unit (ECU) that is part of an assembly that includes both power units monitors the outputs of these two additional pressure transducers and functions to invoke the backup mode and warn personnel should either transducer disclose insufficient pressure for maintaining wheel lock.

In addition to standard components present in a brake system that includes active braking, the following components are used in the disclosed embodiment to endow the system with four wheel lock capability: the locking mechanism mentioned, including suitable anchorage for stable mounting in proximity to the brake pedal shaft; an auxiliary lever on the shaft of the brake pedal lever assembly against which an extensible shaft of the locking mechanism can act to set brake pedal shaft position; the two additional pressure transducers mentioned above; a four wheel lock system enable switch; and a system status lamp. The ECU is adapted to accept the four wheel lock system and to provide certain associated functions.

In order to actuate four wheel lock, the driver first signals the intention to utilize the feature by actuating the enable switch. The change in status of this switch is broadcast on a J1939 data link in the vehicle by the vehicle's ESC (electronic system controller). Upon notification of this change in switch status, the power unit's ECU allows a specified period of time for certain conditions to be met. The system status lamp illuminates.

The conditions presently contemplated are: 1) application of the park brake; and 2) the brake pedal having been depressed by the driver to create substantially stable hydraulic pressure in the wheel brake actuators at some specified minimum pressure, for example pressure within a range of 1600 psi to 2300 psi. If the conditions have not been satisfied within the allotted time limit, the ECU does not allow deployment of the locking mechanism shaft and the system status lamp turns off to indicate that the conditions have not been satisfied, and hence the wheels have not been locked.

If the conditions are satisfied, the locking mechanism shaft is extended to act on the auxiliary lever to hold the brake pedal in that applied position, allowing the driver to release the brake pedal.

With the wheels locked, a change in the hydraulic pressure being measured by one of the additional transducers that indicates an incipient loss of four wheel lock, such as by sensing pressure less than some minimum threshold (900 psi for example) or by a rate of pressure loss exceeding a rate of loss deemed to be excessive (20 psi/second for example), causes a warning to be sounded. Should the pressure continue dropping, such as to a lower level (800 psi for example), the active braking system in the power unit activates to provide backup. A rate of pressure loss exceeding the rate of loss deemed to be excessive may itself automatically activate the active braking system.

One generic aspect of the present invention relates to a motor vehicle comprising wheels on which the vehicle travels and a hydraulic brake system for braking the wheels via depression of a brake pedal acting on a master cylinder to cause hydraulic actuators at the wheels to apply brake torque to the wheels.

The locking system comprises a mechanism for acting on the master cylinder independently of depressing the brake pedal to cause the hydraulic actuators to lock the wheels against rotation while the vehicle is stopped.

An enabler enables a control system to operate the locking system by requiring, as a condition of operating the locking mechanism, that the brake pedal be sufficiently depressed to cause at least a threshold pressure for locking the wheels to be created and maintained at the hydraulic actuators for a defined length of time, and upon fulfillment of the condition, operating the locking system to a state of effectiveness that maintains at least the threshold pressure.

A processor comprises algorithms for attaining and maintaining wheel lock pressure.

For attaining wheel lock pressure, the pressure transducers detect the pressures being applied to the hydraulic actuators that apply the service brakes at the front and rear wheels due to the operator depressing the brake pedal. Other conditions, such as the park brake being applied, may also be sensed by the processor. Upon satisfaction of the specified conditions, including proper hydraulic pressure, the locking system operates.

Distinguished from the aforementioned pressure loss conditions that could invoke active braking, a system may experience pressure loss that is indicative of natural, rather than more extreme, leakage. Such natural leakage is not considered abnormal, but it is not desired because over time, if not managed will continue until active braking is invoked. Natural leakage is therefore managed by an operational scheme that consists of several steps that, when complete, will replenish system pressure to initial level. The replenishment steps comprise: 1) charging the system accumulator to cutout pressure (2330 psi, for example); 2) electronically invoking active braking to apply the replenished accumulator pressure to the wheel brakes; 3) retracting and re-deploying the locking mechanism shaft to maintain the replenished pressure at the wheel brakes by the mechanically locking provided by the locking mechanism; 4) de-activating active braking; and 5) once again continuing to monitor fluid pressure.

Another aspect of the invention relates to a method for locking wheels of a motor vehicle that has a hydraulic brake system for braking the wheels in response to depression of a brake pedal linked to a master cylinder to cause brake fluid to be forced into hydraulic actuators at the wheels.

The method comprises, with the vehicle stationary, causing a locking system that is independent of the brake pedal to act on the master cylinder to cause brake fluid to be forced into the hydraulic actuators after an enabler has enabled the locking system to act on the master cylinder, including requiring, as a condition of operating the locking mechanism, that the brake pedal be sufficiently depressed to cause at least a threshold pressure for locking the wheels to be created and maintained at the hydraulic actuators for a defined length of time. Upon fulfillment of the condition, the locking system operates to a state of effectiveness that maintains at least the threshold pressure.

The foregoing, along with further features and advantages of the invention, will be seen in the following disclosure of a presently preferred embodiment of the invention depicting the best mode contemplated at this time for carrying out the invention. This specification includes drawings, now briefly described as follows.

### BRIEF DESCRIPTION OF THE DRAWINGS

FIG. 1 is a general schematic diagram of a hydraulic brake system embodying principles of the invention.

FIG. 2 is a more detailed schematic diagram of the hydraulic brake system of FIG. 1.

FIG. 3 corresponds to the detailed schematic diagram of FIG. 2, but with active braking, ABS, and powered parking elements removed.

FIG. 4 is a cross section view through a control valve assembly that is present in the system of FIG. 1.

FIG. 5 is a cross section view taken in the direction of arrows 5-5 in FIG. 4.

FIG. 6 is a cross section view taken in the direction of arrows 6-6 in FIG. 4.

FIG. 7 is a cross section view through an accumulator that is present in the system of FIG. 1.

FIG. 8 is a perspective view of another portion of the system.

FIG. 9 is a perspective view of the portion of the system shown in FIG. 8 looking from a different direction.

FIG. 10 is a perspective view in the same direction as FIG. 9 but showing a different operative condition.

FIG. 11 is a portion of a schematic wiring diagram for the system.

FIG. 12 is more of the wiring diagram that includes added components providing the four wheel lock feature.

FIG. 13 is a flow diagram of steps for attaining hydraulic pressure for four wheel lock.

FIG. 14 is a flow diagram of steps for maintaining hydraulic pressure for four wheel lock.

### DESCRIPTION OF THE PREFERRED EMBODIMENT

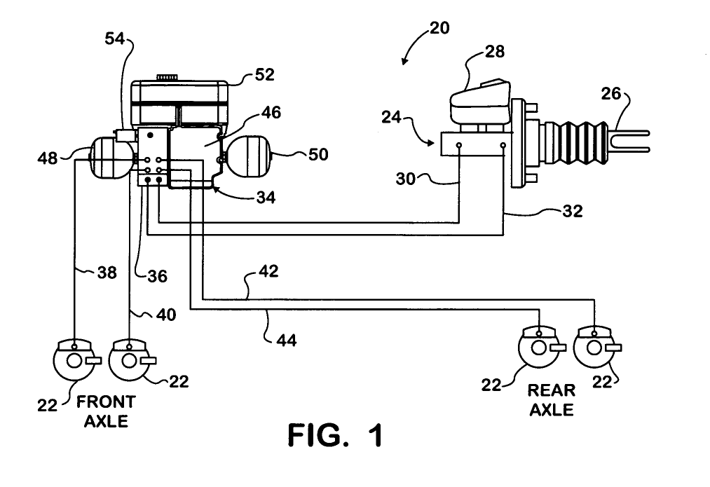

FIG. 1 shows schematically a hydraulic service brake system 20 that is used in a motor vehicle for operating wheel brakes 22 at wheels of the vehicle. The wheel brakes are representatively shown as disc brakes.

System 20 further comprises a master cylinder 24 having a shaft 26. A supply of hydraulic fluid is contained in a reservoir 28 atop master cylinder 24. A foot pedal, not shown in FIG. 1, is operatively connected in any suitably appropriate way to shaft 26 so that when depressed by a driver of the vehicle to apply the brakes, shaft 26 is pushed further into the master cylinder.

System 20 is a split brake system, meaning that master cylinder 24 has two pistons in respective chambers in tandem. When shaft 26 is pushed into master cylinder 24 by depression of the brake pedal, the two pistons move in unison within their respective chambers to cause hydraulic fluid in one chamber to be forced out of that chamber through a brake line 30 and hydraulic fluid in the other chamber to be forced out of that chamber through a brake line 32.

The same quantity of fluid that is forced into line 30 at the master cylinder enters a rear wheel brake power unit of a brake power unit assembly 34. The same quantity of fluid that is forced into line 32 at the master cylinder enters a front wheel brake power unit of assembly 34.

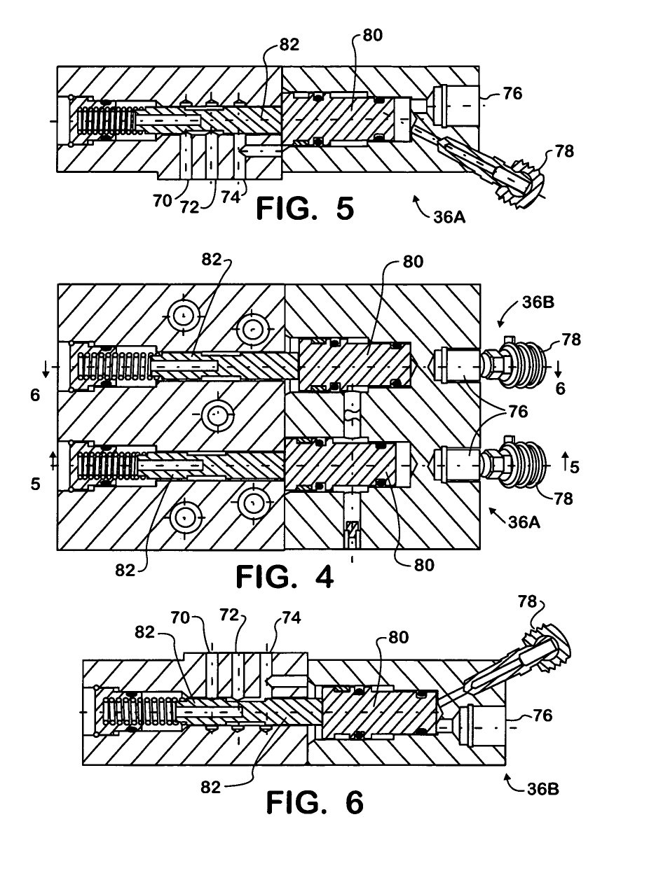

Assembly 34 comprises a control valve assembly 36 that houses separate control valves 36A, 36B (see FIGS. 4, 5, and 6) that control the delivery of brake fluid to the front and rear brakes respectively. Control valve 36A therefore is part of one power unit and control valve 36B part of the other power unit.

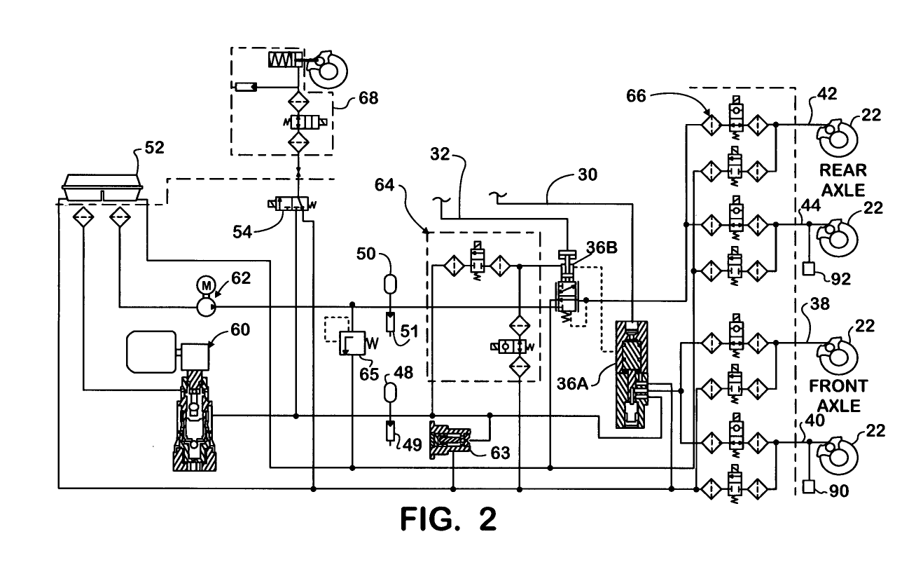

FIG. 2 shows that fluid from control valve 36A is delivered to respective hydraulic actuators for the front wheel brakes through respective brake lines 38, 40. Fluid from control valve 36B is delivered to respective hydraulic actuators for the rear wheel brakes through respective brake lines 42, 44.

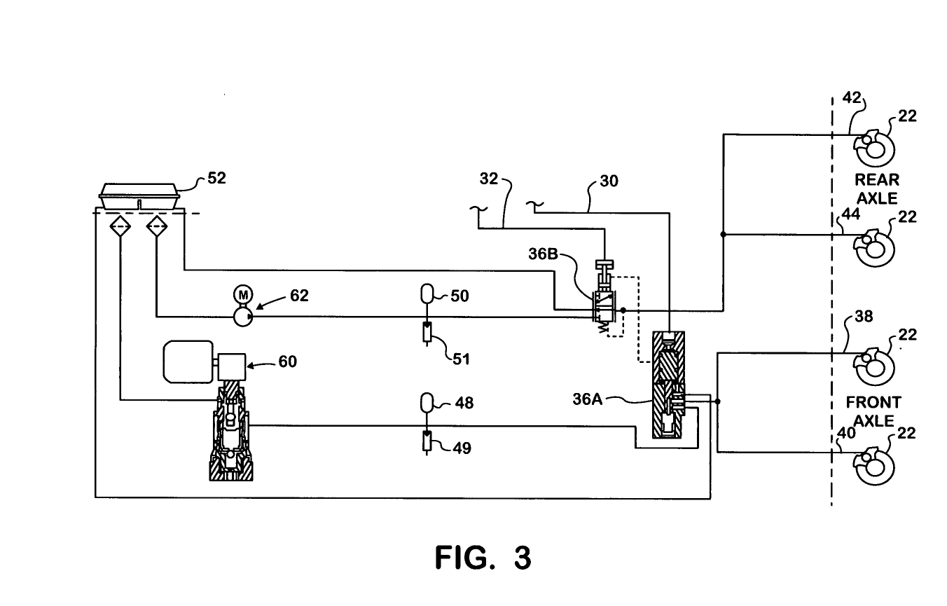

In addition to the service brake function that results from application of the brake pedal, the brake power units are capable of performing active braking and control functions. Components enabling the respective power units to perform active braking, meaning to perform a function like traction control or stability control by applying the brakes other than via master cylinder 24, are shown in FIGS. 2 and 3. The front wheel brake power unit includes a motorized hydraulic pump assembly 60, a pressure relief valve 63, and a hydraulic accumulator 48. The rear wheel brake power unit includes a motorized hydraulic pump assembly 62, a pressure relief valve 65, and a hydraulic accumulator 50. Active braking valves 64 are common to both front and rear wheel brake power units. A supply of hydraulic fluid for the two brake power units is contained in a respective portion of a reservoir 52 atop assembly 34.

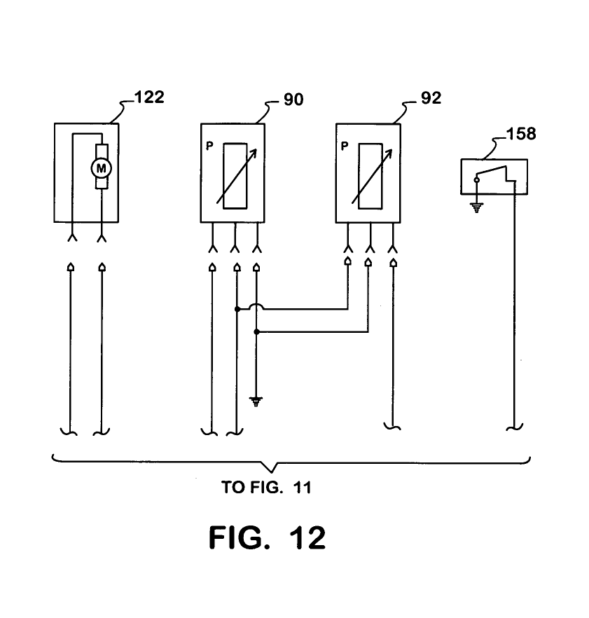

An electronic control unit (ECU) 46 that is part of assembly 34 controls electric-operated components in assembly 34 and interfaces with the vehicle electrical system as will be more fully explained with reference to FIGS. 11 and 12.

FIG. 2 corresponds to FIG. 1 but with more detail. Assembly 34 is shown to further comprise active braking components 64, anti-lock components 66, a pressure transducer 49 for measuring hydraulic pressure in accumulator 48, and a pressure transducer 51 for measuring hydraulic pressure in accumulator 50. An electric-actuated valve 54 in assembly 34 is used to control a SAHR (spring-apply, hydraulic-release) device 68 that applies and releases the park brake. It is connected into the vehicle electric system by a connector 56. The system shown in FIG. 3 is like that of FIG. 2, but with items 54, 64, and 68 removed to make the drawing easier to follow when explaining general principles.

Detail of control valves 36A, 36B is shown in FIGS. 4, 5, and 6. Control valve 36A is shown fully open, and control valve 36B, closed, for illustrative purposes only. There are four ports 70, 72, 74, and 76 associated with each control valve. Port 70 is an inlet port connected to the passage from the respective pump and accumulator. Port 72 is an outlet port through which fluid is delivered to the corresponding wheel brake actuators, either front or rear. Port 74 is a return port for fluid to pass back to reservoir 52. Port 76 is an inlet port to which the respective line 30, 32 from master cylinder 24 connects. A respective bleeder screw 78 tees into internal space between each port 76 and the head end of a piston 80 that can move axially within the respective control valve. Each bleeder screw is normally closed but opens to allow trapped air to be vented when bleeding each hydraulic system.

In addition to piston 80, the mechanism of each control valve 36A, 36B comprises a spring-biased valve spool 82 against an inner end joined to the confronting end of the respective piston. When no fluid pressure is being applied to the head end of a piston, as shown for piston 80 of control valve 36B, the respective spool 82 assumes a position where port 72 is not communicated to port 70, but is instead communicated to port 74. When full fluid pressure is being applied to the head end of the respective piston, as shown for control valve 36A, its spool 82 assumes a position where port 72 is communicated to port 70, but not to port 74. In the pressure range between these limits, the communication between ports 72 and 74 is restricted thereby causing the brake fluid pressure that is delivered to the corresponding wheel brake actuators to be a function of the pressure being applied to the respective piston from master cylinder 24.

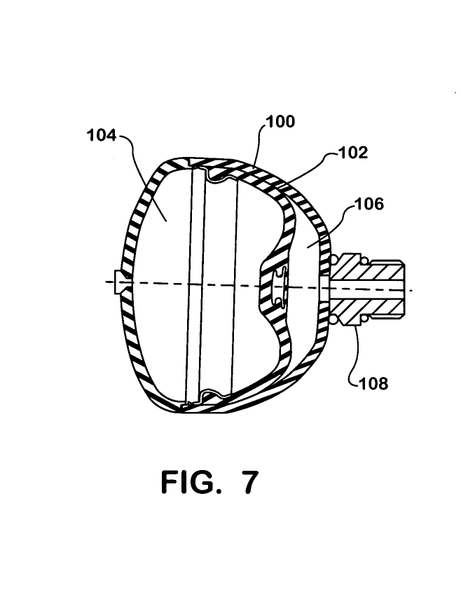

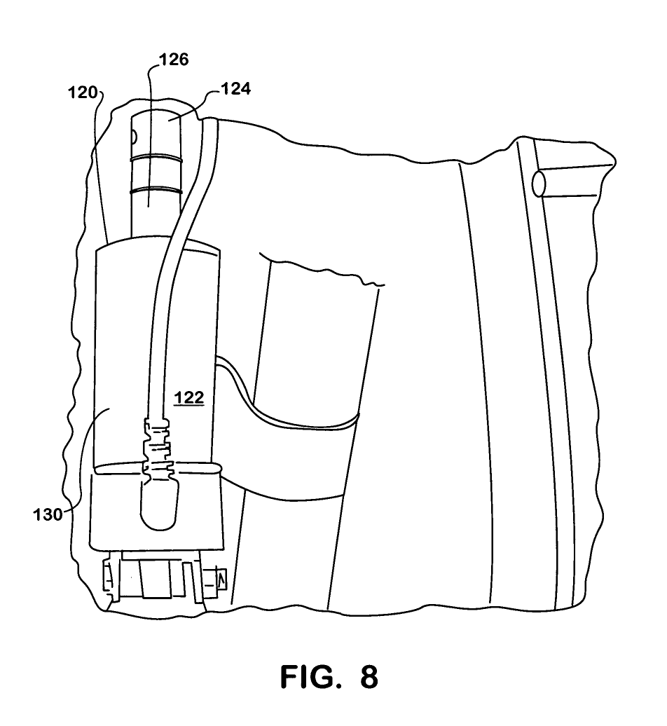

As shown by FIG. 7, each accumulator comprises a housing 100 whose interior is divided by a movable wall, or bladder, 102 into a variable volume pre-charged gas chamber 104 and a variable volume brake fluid chamber 106. A fitting 108 is fit to a hole in one axial end of housing 100 and sealed to the hole, such as by welding, to serve as a port for allowing the interior of chamber 106 to be teed into a fluid passage between the outlet of the respective pump 60, 62 and an inlet port of the respective control valve 36A, 36B. FIG. 7 shows the condition where bladder 102 is displaced a short distance from the end of the housing containing fitting 108.

When the respective pump operates while the respective control valve is closed, hydraulic fluid is pumped under increasing pressure through fitting 108 into chamber 106, displacing wall 102 and further compressing the trapped gas present in chamber 104. The pressure rises within chamber 104 approximately according to the ideal gas law to maintain essentially equal pressure on the gas side with the pressure on the brake fluid side. Hence, the extent to which wall 102 is displaced, and hence the extent to which chamber 106 is filled with hydraulic fluid, depends on the pressure delivered by the respective pump.

Charging chamber 106 with hydraulic fluid under pressure enables the system to promptly supply the fluid volume requirements of the wheel brake actuators for both service and active braking when the respective control valve is opened.

The portion of the system shown in FIGS. 8, 9, and 10 comprises a mechanism 120 for operating master cylinder 24 independently of depressing the brake pedal. Acting via the brake pedal shaft, mechanism 120 functions to cause master cylinder 24 to develop and maintain a suitable pressure for four wheel lock, provided that certain conditions have been satisfied after four wheel lock has been enabled, as will be more fully explained hereinafter. In this way the mechanism keeps the brake pedal shaft in a position of brake application in the same way as if the brake pedal itself were being depressed in a corresponding amount. As set by mechanism 120, the brake pedal shaft position creates a bounded predictable caliper or shoe pressure for locking the brakes hydraulically.

The disclosed mechanism 120 is an electromechanical one, comprising a linear actuator 122 having a shaft 124 protruding from one axial end of a housing 126 whose opposite end is anchored to a structurally stable portion of the vehicle, such as the floor of a truck cab laterally adjacent a brake pedal that is affixed to a generally horizontal brake pedal shaft 128.

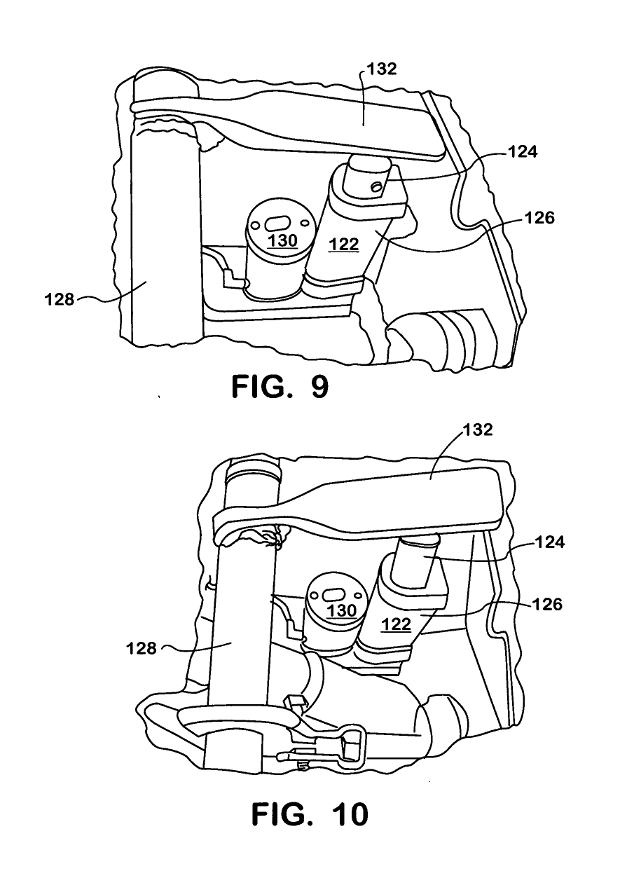

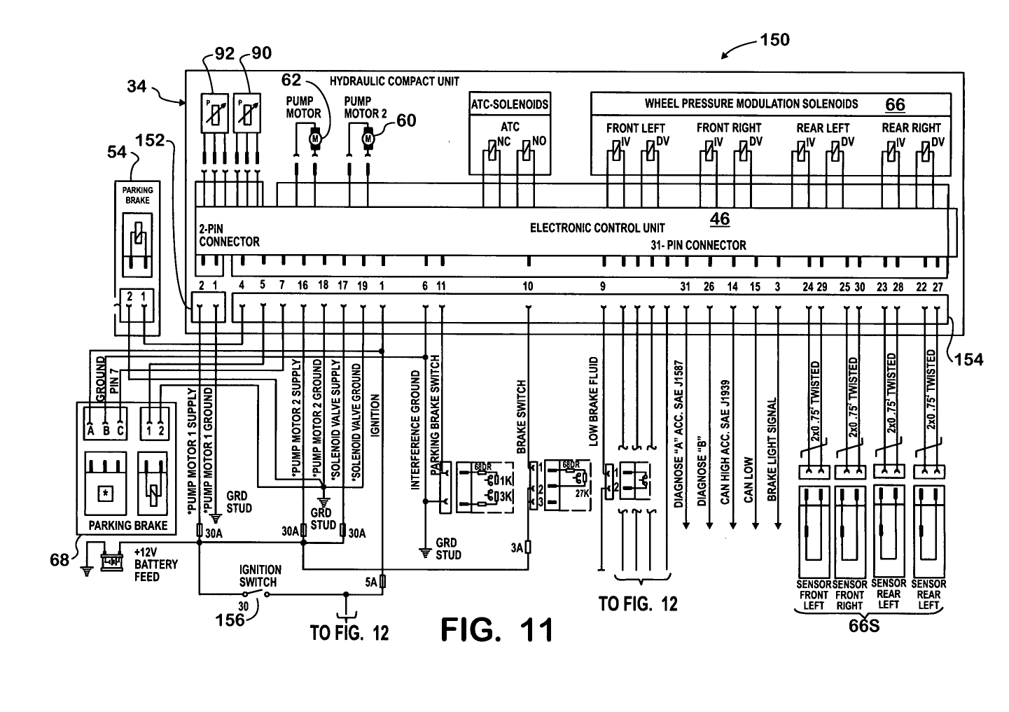

Shaft 124 is linearly displaceable from a retracted position shown in FIGS. 8 and 9 to the extended position shown in FIG. 10. When stroked from the retracted position to the extended position by operation of an electric motor 130, shaft 124 is displaced a fixed distance. Voltage of a specified polarity is applied to motor 130 to extend shaft 124. When the shaft arrives at extended position, an internal limit switch is tripped to shut off the current flow to motor 130.

Shaft 124 is disposed for acting on an auxiliary lever 132 that is affixed to brake pedal shaft 128 adjacent the attachment of the brake pedal to the latter shaft. With the brake pedal not being depressed by the driver, a certain amount of extension of shaft 124 is needed before the end of the shaft can contact auxiliary lever 132 at a location that is spaced from the axis of brake pedal shaft 128. By making the stroke of shaft 124 slightly greater than that amount, shaft 124 will force auxiliary lever 132 to turn brake pedal shaft 128 some angular distance before shaft 124 reaches extended position.

When the extended shaft is to be retracted, voltage of polarity opposite the polarity used to extend the shaft is applied to motor 130. When the shaft reaches retracted position, another internal limit switch is tripped to shut off current to the motor. In the absence of any voltage to motor 130, shaft 124 cannot move and will stay in whatever position it presently is in. This is a desirable feature because maintenance of shaft 124 in extended position doesn't depend on the continued application of electricity to motor 130. Hence, if power to actuator 122 were lost for any reason, such as a broken wire, with shaft 124 in extended position, shaft 124 would remain in that position to continue exerting torque on brake pedal shaft 128 that is balanced by a counter-torque from the hydraulic pressure being applied by master cylinder and internal return springs acting on its pistons.

The wiring diagram 150 of FIG. 11 shows ECU 46, valve 54 and SAHR device 68, motorized pumps 60, 62, solenoids for modulating solenoid valves of the various anti-lock components 66, wheel speed sensors 66S that are used in conjunction with anti-lock control, and pressure transducers 49, 51. FIG. 11 further shows a two-pin connector 152 and a thirty-one-pin connector 154 that enable ECU 46 to make electric circuit connections with components that are not contained in assembly 34. FIG. 11 also shows the vehicle's ignition switch 156. FIG. 12 shows actuator 122, the additional pressure transducers 90, 92 (which cannot be seen in FIG. 1), and an enable switch 158.

Motor 122 and switch 158 are external to assembly 34. Transducers 90, 92 are arranged in assembly 34 to sense hydraulic pressure being delivered to the front and rear brakes respectively, as portrayed in FIG. 2. In the absence of anti-lock operation, the hydraulic pressure at both front wheel brakes is the same, and that is also true of pressure at the rear wheel brakes. Hence, only one transducer 90 is needed for the front brake hydraulics and one transducer 92 for the rear, although additional ones could be added for redundancy if desired.

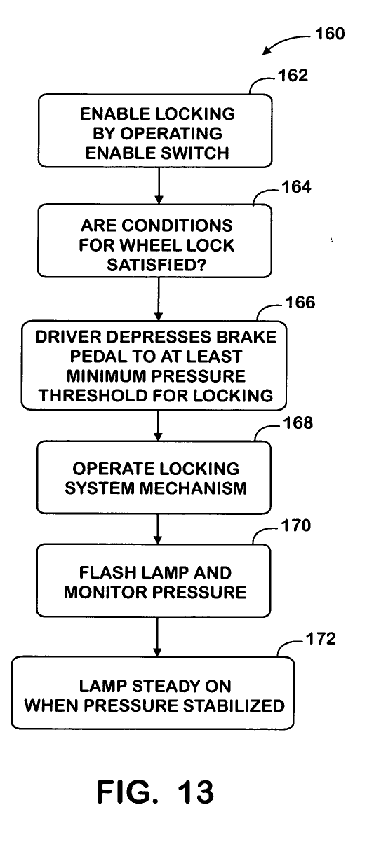

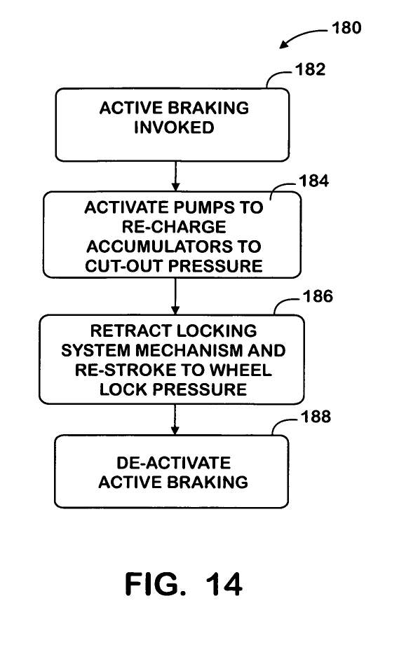

The disclosed embodiment operates in the following way to lock the wheels with reference to the sequence shown in FIG. 13. With the vehicle parked, ignition switch 156 is turned on. The four wheel lock enable switch is toggled to the “enable” position to begin what may be considered a System Initiation Phase. In response to the toggling, ECU 46 activates algorithms specific to the four wheel lock function, such as the one 160 shown in FIG. 13. FIG. 11 shows that there are also certain direct battery feeds to ECU 46.

When enable switch 158 is operated (step 162 in FIG. 13), ECU 46 allows a certain amount of time for certain necessary conditions precedent to locking the wheels to be satisfied (step 164). Those conditions are essentially ones for assuring that the vehicle is indeed stationary and that the driver truly intends to lock the wheels. For assuring that the vehicle is stationary, the embodiment shown here uses a signal indicating that the park brake is applied.

For assuring that the driver intends to lock the wheels, it is necessary that he/she depress the brake pedal with sufficient force to create hydraulic pressure in the brake lines to the front and rear wheels that will lock the wheels (step 166). Pressure within a range of 1600 psi to 2300 psi was mentioned above as typical pressure.

Even if application of the park brake is detected by ECU 46, failure to create substantially stable pressures in the front and rear brake lines within the allotted time, as measured by transducers 90, 92, will be detected by ECU 46 and appropriately indicated by the system status lamp turning off. Likewise failure to detect application of the park brake will cause the same indication be given even if the proper pressure conditions for wheel lock have been detected.

Assuming that the enabling conditions for wheel lock (steps 164, 166) have been satisfied, step 168 is performed by ECU 46 causing proper polarity voltage to be applied to motor 130 to extend shaft 124 into initial engagement with auxiliary lever 132. The final increment of displacement of shaft 124 to extended position acts via lever 132 to turn the brake pedal shaft in some amount depending on the extent to which the operator's foot is depressing the brake pedal. When shaft 124 has been deployed to extended position, actuator 122 functions to hold the shaft extended. ECU 46 confirms deployment, first by causing the system status lamp to flash until pressure substantially stabilizes at some value that is typically in excess of the pressure that was being applied by the operator (step 170). Once proper pressure stability has been attained, the lamp continuously illuminates as an indication that wheel lock has been attained (step 172). The system may now be considered to be in a Wheel Locking Phase.

Another algorithm represented by the flow diagram 180 in FIG. 13 assures that pressure, once attained, is maintained. If a loss of pressure, such as one of the ones mentioned earlier, is detected by one of the pressure transducers 90, 92, a Pressure Replenishment Phase ensues. Active braking is immediately invoked (step 182), and depending on whether the pressure loss is in the front brakes, the rear brakes, or both, either or both pumps 60, 62 begin operating to restore pressure by re-charging one or both accumulators 48, 50 (step 184). When pressure has been restored by having invoked active braking, the pump, or pumps, that had been operating stop. Active braking continues being invoked while step 186 is performed.

Step 186 comprises retracting the extended shaft 124 and then re-stroking it to extended position to turn the brake shaft to a position that applies four wheel lock pressure via the master cylinder and the brake power units. With wheel lock pressure once again being applied by the brake pedal shaft, active braking is de-activated (step 188) and the system once again assumes the Wheel Locking Phase.

From the foregoing description, operation of the four wheel lock system may be summarized by its operational phases. During the System Initiation Phase, certain conditions precedent to attaining four wheel lock, such as those mentioned earlier, must occur. Once they have, the system enters the Wheel Locking Phase during which the wheels are kept locked by the locking mechanism and pressure at the wheel brakes is monitored. If wheel brake pressure needs replenishment for any of the reasons described above, the system enters the Pressure Replenishment Phase, and upon wheel brake pressure being restored, it returns to the Wheel Locking Phase.

While a presently preferred embodiment of the invention has been illustrated and described, it should be appreciated that principles of the invention apply to all embodiments falling within the scope of the following claims.

What is claimed is:

1. A motor vehicle comprising:
wheels on which the vehicle travels;
a hydraulic brake system for braking the wheels via depression of a brake pedal acting on a master cylinder to cause hydraulic actuators at the wheels to apply brake torque to the wheels;
a locking system for causing the hydraulic actuators to lock the wheels against rotation while the vehicle is stopped;
the locking system comprising a mechanism for acting on the master cylinder independently of depressing the brake pedal to cause the hydraulic actuators to lock the wheels against rotation;
an enabler for enabling a control system to operate the locking system by requiring, as a condition of operating the locking mechanism, that the brake pedal be sufficiently depressed to cause at least a threshold pressure for locking the wheels to be created and maintained at the hydraulic actuators for a defined length of time, and upon fulfillment of the condition, operating the locking system to a state of effectiveness that maintains at least the threshold pressure.

2. A motor vehicle as set forth in claim 1 wherein the control system comprises logic that conditions operation of the locking mechanism on satisfaction of one or more additional conditions within the defined time limit.

3. A motor vehicle as set forth in claim 2 further including a park brake and wherein one of the additional conditions comprises the park brake being set.

4. A motor vehicle as set forth in claim 1 further including an active braking system for operating the hydraulic actuators at the wheels independently of the master cylinder, and wherein the control system is effective to cause the active braking system to begin operating the hydraulic actuators at the wheels when hydraulic pressure in the hydraulic actuators changes in a way indicating incipient loss of adequate wheel locking pressure while the locking system is operating to lock the wheels via the hydraulic actuators.

5. A motor vehicle as set forth in claim 4 wherein the control system is effective to cause the active braking system to begin operating the hydraulic actuators at the wheels when hydraulic pressure in the hydraulic actuators decreases at a rate greater than a defined rate.

6. A motor vehicle as set forth in claim 4 wherein the control system is effective to cause the active braking system to begin operating the hydraulic actuators at the wheels when hydraulic pressure in the hydraulic actuators becomes less than a defined pressure.

7. A motor vehicle as set forth in claim 5 wherein the control system also causes a warning signal to issue when pressure in the hydraulic actuators changes in a way indicating incipient loss of adequate wheel locking pressure while the locking system is operating to lock the wheels via the hydraulic actuators.

8. A motor vehicle as set forth in claim 1 wherein the locking system comprises an electromechanical actuator having a linearly displaceable shaft that acts on a lever attached to a shaft for operating the master cylinder independently of depressing the brake pedal.

9. A motor vehicle as set forth in claim 8 wherein the electromechanical actuator is supported on a floor of a cab of the vehicle with the shaft be displaceable in a generally vertical direction.

10. A method for locking wheels of a motor vehicle that has a hydraulic brake system for braking the wheels in response to depression of a brake pedal linked to a master cylinder to cause brake fluid to be forced into hydraulic actuators at the wheels, the method comprising:
with the vehicle stationary, causing a locking system that is independent of the brake pedal to act on the master cylinder to cause brake fluid to be forced into the hydraulic actuators after an enabler has enabled the locking system to act on the master cylinder, including requiring, as a condition of operating the locking mechanism, that the brake pedal be sufficiently depressed to cause at least a threshold pressure for locking the wheels to be created and maintained at the hydraulic actuators for a defined length of time, and upon fulfillment of the condition, operating the locking system to a state of effectiveness that maintains at least the threshold pressure.

11. A method as set forth in claim 10 further comprising conditioning operation of the locking mechanism on satisfaction of one or more additional conditions within the defined time limit.

12. A method as set forth in claim 11 wherein the step of conditioning operation of the locking mechanism on satisfaction of one or more additional conditions within the defined time limit comprises conditioning operation of the locking mechanism on a park brake of the vehicle being set.

13. A method as set forth in claim 10 further including causing an active braking system to begin forcing brake fluid into the hydraulic actuators at the wheels when hydraulic pressure in the hydraulic actuators changes in a way indicating incipient loss of adequate wheel locking pressure while the locking system is operating to lock the wheels via the hydraulic actuators.

14. A method as set forth in claim 13 wherein the step of causing the active braking system to begin forcing brake fluid into the hydraulic actuators comprises beginning to force brake fluid into the hydraulic actuators when hydraulic pressure in the hydraulic actuators decreases at a rate greater than a defined rate.

15. A method as set forth in claim 13 wherein the step of causing the active braking system to begin forcing brake fluid into the hydraulic actuators comprises beginning to force brake fluid into the hydraulic actuators when hydraulic pressure in the hydraulic actuators becomes less than a defined pressure.

16. A method as set forth in claim 13 further comprising causing a warning signal to issue when pressure in the hydraulic actuators changes in a way indicating incipient loss of adequate wheel locking pressure while the locking system is operating to lock the wheels via the hydraulic actuators.

17. A method as set forth in claim 10 wherein the step of operating the locking system comprises displacing a linearly displaceable shaft of an electromechanical actuator to act on a lever attached to a brake pedal shaft of the vehicle.
